(19) United States
(12) Patent Application Publication
(10) Pub. No.: US 2015/0185826 A1
(43) Pub. Date: Jul. 2, 2015

(54) MAPPING GESTURES TO VIRTUAL FUNCTIONS

(71) Applicant: DAQRI, LLC, Los Angeles, CA (US)

(72) Inventor: Brian Mullins, Garden Grove, CA (US)

(21) Appl. No.: 14/144,395

(22) Filed: Dec. 30, 2013

(51) Int. Cl. G06F 3/01; G06T 19/00

(52) U.S. Cl. CPC G06F 3/011; G06T 19/006; G06F 3/017; G06T 2215/16

(57) ABSTRACT

Techniques of mapping gestures to virtual functions are disclosed. In some embodiments, a software application is run on a computing device. The software application may have a first virtual function configured to manipulate a virtual object of the software application in a first predefined way. First image data of a first physical content may be captured using the computing device. A first gesture over the first physical content may be mapped to the first virtual function using the first image data. The virtual object may be displayed over a view of the first physical content on a display screen of the computing device. The first gesture over the first physical content may be detected. The virtual object may be manipulated in the first predefined way in response to detecting the first gesture over the first physical content.

### TECHNICAL FIELD

The present application relates generally to the technical field of data processing, and, in various embodiments, to methods and systems of mapping gestures to virtual functions.

### BACKGROUND

Augmented reality is a live, direct or indirect, view of a physical, real-world environment whose elements are augmented by computer-generated sensory input, such as sound, video, graphics, or GPS data. Currently, the controls of predefined functions of software applications lack a meaningful connection with the physical, real-world environment in which they are being used.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a computing device, in accordance with some embodiments;

FIG. 2 is a block diagram illustrating an augmented reality module, in accordance with some embodiments;

FIGS. 3A-3B illustrate a mapping of gestures over physical content to virtual functions, in accordance with some embodiments;

FIGS. 4A-4C illustrate an example embodiment of the augmented reality module being employed to provide an augmented reality experience;

FIG. 5 is a flowchart illustrating a method of providing an augmented reality experience, in accordance with some embodiments;

FIG. 6 illustrates a mapping of virtual functions to virtual functions parameters, in accordance with some embodiments;

FIG. 7 is a flowchart illustrating a method of mapping gestures over physical content to virtual functions, in accordance with some embodiments;

FIG. 8 is a block diagram of an example computer system on which methodologies described herein may be executed, in accordance with some embodiments; and

FIG. 9 is a block diagram illustrating a mobile device, in accordance with some embodiments.

### DETAILED DESCRIPTION

Example methods and systems of mapping gestures to virtual functions are disclosed. In the following description, for purposes of explanation, numerous specific details are set forth in order to provide a thorough understanding of example embodiments. It will be evident, however, to one skilled in the art that the present embodiments may be practiced without these specific details.

In some embodiments, a software application is run on a computing device having a memory and at least one processor. The software application may have a first virtual function configured to manipulate a virtual object of the software application in a first predefined way. First image data of a first physical content may be captured using the computing device. A first gesture over the first physical content may be mapped to the first virtual function using the first image data. The virtual object may be displayed over a view of the first physical content on a display screen of the computing device. The first gesture over the first physical content may be detected. The virtual object may be manipulated in the first predefined way in response to detecting the first gesture over the first physical content.

In some embodiments, second image data of a second physical content is captured using the computing device. The first gesture over the second physical content may be mapped to the first virtual function using the second image data. The virtual object may be displayed over a view of the second physical content on the display screen of the computing device. The first gesture over the second physical content may be detected. The virtual object may be manipulated in the first predefined way in response to detecting the first gesture over the second physical content.

In some embodiments, the mapping of the first gesture over the first physical content to the virtual function using the first image data, the manipulating of the virtual object in the first predefined way in response to detecting the first gesture over the first physical content, the mapping of the first gesture over the second physical content to the virtual function using the second image data, and the manipulating of the virtual object in the first predefined way in response to detecting the first gesture over the second physical content are all performed during a single run of the software application.

In some embodiments, the first physical content comprises a physical object, and the first gesture over the first physical content comprises a touch of a first location on a surface of the physical object. In some embodiments, the first physical content comprises a physical space, and the first gesture over the first physical content comprises a movement on a first location within the physical space.

In some embodiments, detecting the first gesture over the first physical content comprises detecting the first gesture using captured image data of the first gesture.

In some embodiments, the software application has a second virtual function configured to manipulate the virtual object of the software application in a second predefined way different from the first predefined way. A second gesture over the first physical content may be mapped to the second virtual function using the first image data. The second gesture over the first physical content may be detected. The virtual object may be manipulated in the second predefined way in response to detecting the second gesture over the first physical content.

In some embodiments, the first image data of the first physical content is analyzed using at least one computer vision technique. At least one parameter of the first virtual function may be determined. The first gesture over the first physical content may be mapped to the first virtual function using the at least one parameter of the first virtual function.

In some embodiments, the computing device comprises one of a smart phone, a tablet computer, and a wearable computing device

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

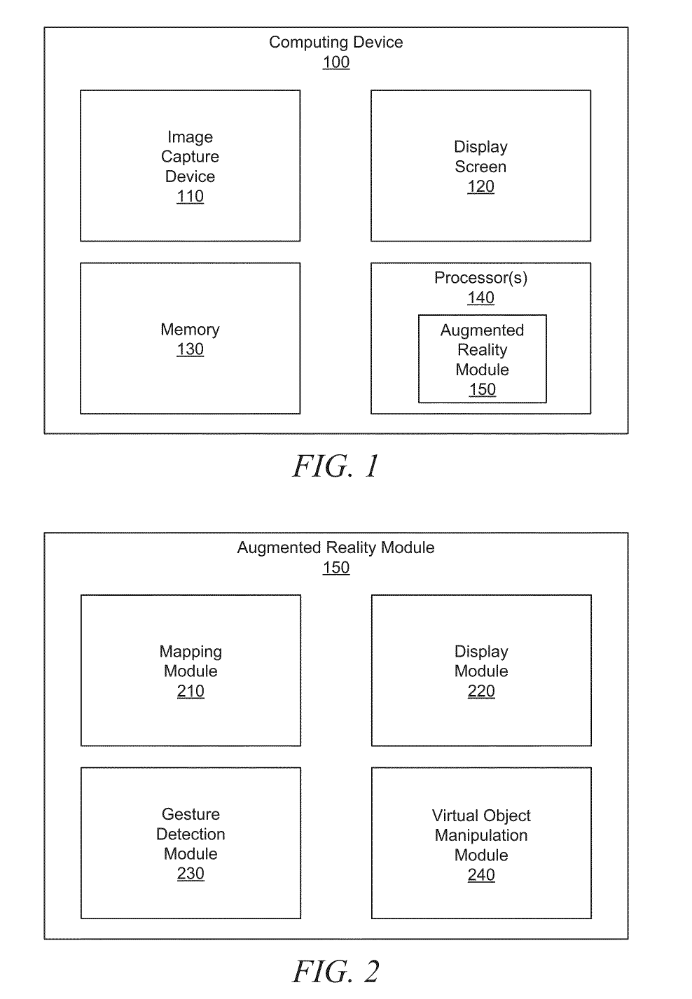

FIG. 1 is a block diagram illustrating a computing device 100, in accordance with some embodiments. Computing device 100 may comprise a smart phone, a tablet computer, a wearable computing device, a vehicle computing device, a laptop computer, and a desktop computer. However, it is contemplated that other types of computing devices 100 are also within the scope of the present disclosure. In some embodiments, the computing device 100 comprises an image capture device 110, a display screen 120, memory 130, and one or more processors 140.

In some embodiments, the image capture device 110 comprises a built-in camera or camcorder with which a user of the computing device 100 can use to capture image data of physical content in a real-world environment. The image data may comprise one or more still images or video. Other configurations of the image capture device 110 are also within the scope of the present disclosure.

In some embodiments, the display screen 120 comprises a touchscreen configured to receive a user input via a contact on the touchscreen. Although, other types of display screens 120 are also within the scope of the present disclosure. In some embodiments, the display screen 120 is configured to display the image data captured by the image capture device 110. In some embodiments, the display screen 120 is transparent or semi-opaque so that the user of the computing device 100 can see through the display screen 120 to the physical content in the real-world environment.

In some embodiments, an augmented reality module 150 is stored in memory 130 or implemented as part of the hardware of the processor(s) 140, and is executable by the processor(s) 140. Although not shown, in some embodiments, the augmented reality module 150 may reside on a remote server and communicate with the computing device 100 via a network. The network may be any network that enables communication between or among machines, databases, and devices. Accordingly, the network may be a wired network, a wireless network (e.g., a mobile or cellular network), or any suitable combination thereof. The network may include one or more portions that constitute a private network, a public network (e.g., the Internet), or any suitable combination thereof.

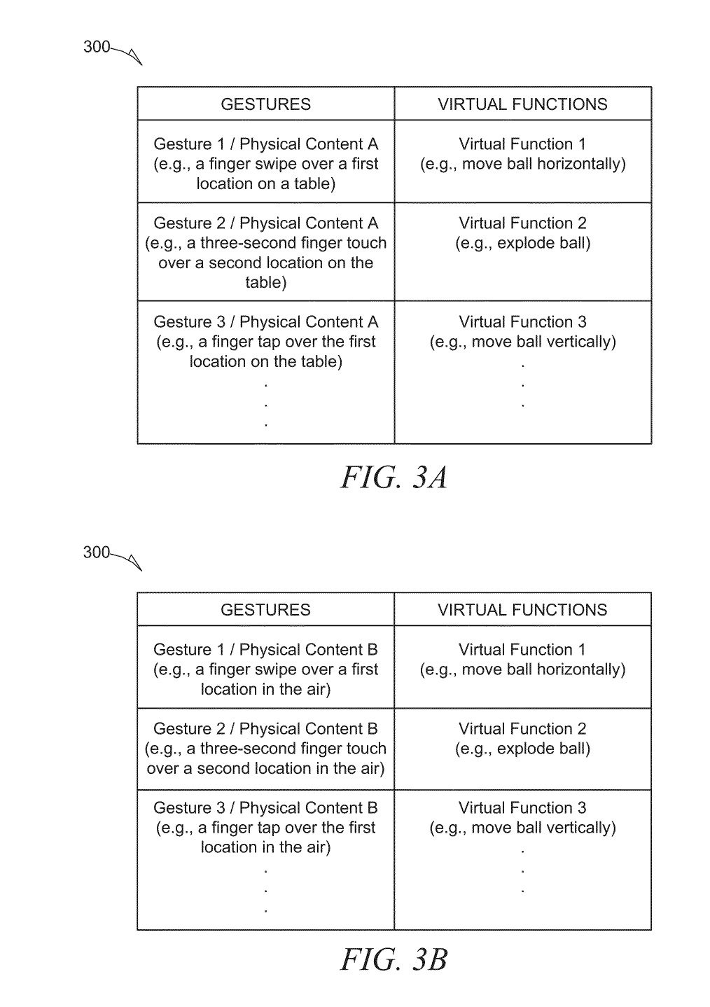

FIG. 2 is a block diagram illustrating the augmented reality module 150, in accordance with some embodiments. The augmented reality module 150 may be configured to operate in conjunction with a software application that is running on the computing device 100. The software application can have one or more virtual functions. Each virtual function may be configured to manipulate a virtual object of the software application in a corresponding predefined way. A virtual object may be any object that can be displayed on the display screen 120 of the computing device 100 in accordance with the environment created by the software application, but that does not exist in a physical, real-world environment. Certain gestures may be used by a user of the software application to execute certain virtual functions of the software application in order to manipulate the virtual object in corresponding predefined ways. Different types of manipulation of virtual objects can be employed. Examples of manipulation include, but are not limited to, positional translation of virtual objects, addition of virtual objects (e.g., a virtual object appearing on the display screen), addition of graphic effects on virtual objects, removal of virtual objects (e.g., a virtual object disappearing from the display screen), and removal of graphic effects on virtual objects. Other types of manipulation are also within the scope of the present disclosure.

In one example, the software application may comprise a game that involves the movement of a ball. The ball may be a virtual object of the game, as it is displayed on the display screen during the running of the game on the computing device. The user may perform a particular gesture, such as swiping the display screen at a particular location on the display screen 120 in a particular way, thereby causing a corresponding virtual function. This virtual function may be to manipulate the ball in a predefined way, such as to make the ball move in a direction and to a degree corresponding with the swipe. Other examples are also within the scope of the present disclosure.

In some embodiments, augmented reality module 150 comprises a mapping module 210, a display module 220, a gesture detection module 230, and a virtual object manipulation module 240.

The mapping module 210 may be configured to receive captured image data of physical content (e.g., image data captured by the image capture device 110), and to map one or more gestures over the physical content to corresponding virtual functions of the software application using the received image data. In some embodiments, the physical content comprises a physical object (e.g., a table or a wall), and one or more of the gestures over the physical content comprise a touch of a location on a surface of the physical object. In some embodiments, the physical content comprises a physical space (e.g., air), and one or more of the gestures over the physical content comprise a movement on a location within the physical space.

The display module 220 may be configured to display one or more virtual objects of the software application over a view of the physical content on the display screen 120 of the computing device 100. The display module 220 may also be configured to display any manipulation of the virtual object(s) on the display screen 120.

The gesture detection module 230 may be configured to detect any of the gestures made over the physical content. In some embodiments, the gesture detection module 230 detects a gesture using image data of the gesture captured by the image capture device 110. The gesture detection module 230 may employ one or more computer vision techniques to detect gestures. Computer vision techniques may include processing, analyzing, and understanding image data in order to produce information. Examples of computer vision techniques may include, but are not limited to, gesture recognition, image recognition, and object recognition. Other techniques for detecting gestures are also within the scope of the present disclosure.

The virtual object manipulation module 240 may be configured to manipulate a virtual object of the software application in the predefined way of the virtual function corresponding to the detected gesture in response to the gesture being detected. In some embodiments, the virtual object manipulation module 240 accesses a mapping of gestures to virtual functions of the software application in order to determine the corresponding predefined way to manipulate the virtual object.

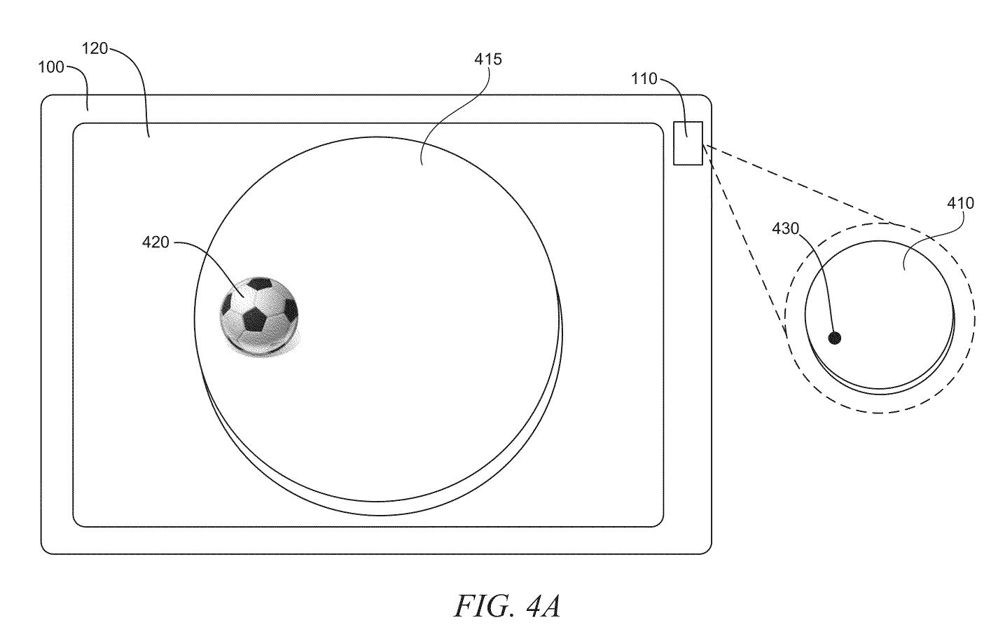

FIG. 3A illustrates a mapping 300 of gestures over physical content to virtual functions, in accordance with some embodiments. In FIG. 3A, Gesture 1 over Physical Content A (e.g., a hand swipe over a first location on the table) is mapped to Virtual Function 1 (e.g., moving the ball horizontally), Gesture 2 over Physical Content A (e.g., a three-second touch over a second location on the table) is mapped to Virtual Function 2 (e.g., exploding the ball), Gesture 3 over Physical Content A (e.g., a finger tap over the first location on the table) is mapped to Virtual Function 3 (e.g., moving the ball vertically), and so on and so forth.

The user of the software application may change the real-world physical content over which the virtual object(s) of the software application are being displayed on the display screen 120 of the computing device. FIG. 3B illustrates the mapping 300 of gestures over physical content to virtual functions after the user had changed the real-world physical content (e.g., from the table to the air). In FIG. 3B, Gesture 1 over Physical Content B (e.g., a hand swipe over a first location in the air) is mapped to Virtual Function 1 (e.g., moving the ball horizontally), Gesture 2 over Physical Content B (e.g., a three-second touch over a second location in the air) is mapped to Virtual Function 2 (e.g., exploding the ball), Gesture 3 over Physical Content B (e.g., a finger tap over the first location in the air) is mapped to Virtual Function 3 (e.g., moving the ball vertically), and so on and so forth.

In some embodiments, virtual functions are scaled based on an analysis of the image data of the real-world physical content. This analysis may involve the consideration of spatial relationships, coordinates, positions, and dimensions of one or more elements of the real-world physical content. For example, in a scenario where the physical content comprises a table, the dimensions of the table along with the location of its edges may be used to determine how to implement the virtual objects in their display over the table (e.g., the size and positioning of the virtual objects), as well as any virtual functions on the virtual objects being displayed over the table (e.g., how the virtual objects are manipulated, such as direction, speed, and amount/degree of translation). Furthermore, this information and analysis may also be used to determine how to interpret gestures within the context of the current real-world physical content. Accordingly, this information and analysis can be used in mapping the gestures to the virtual functions.

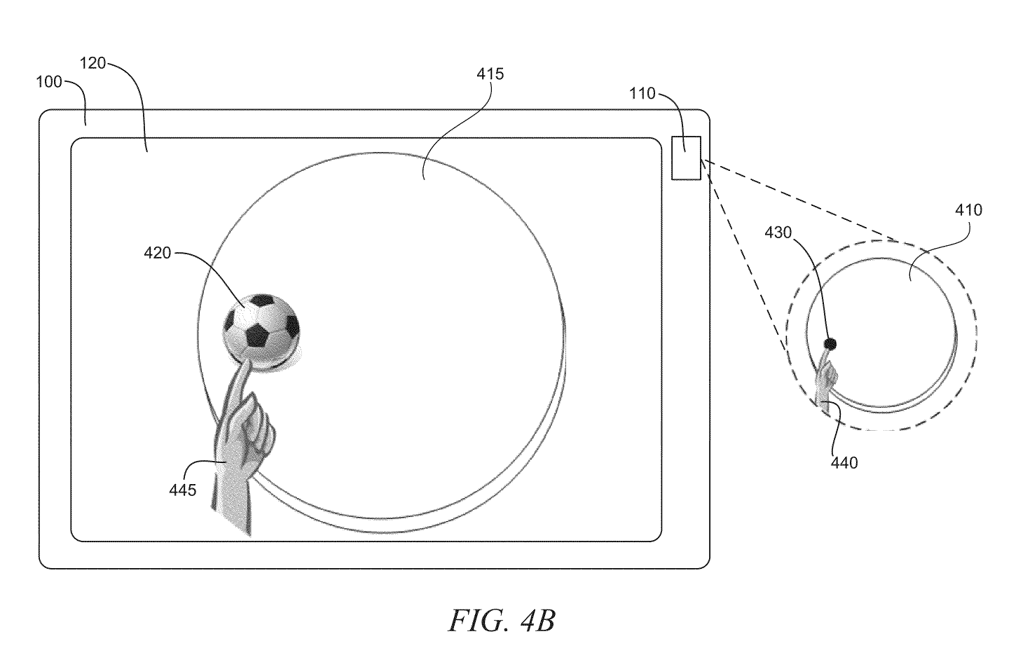

FIGS. 4A-4C illustrate an example embodiment of the augmented reality module 150 being employed to provide an augmented reality experience. In FIG. 4A, computing device 100 is being used to provide the augmented reality experience over real-world physical content, which is a table 410 in this example. A software application is running on the computing device 100. Image data of the table 410 is captured by the image capture device 110 of the computing device 100. A view 415 of the table 410 is made visible via the display screen 120. In some embodiments, the view 415 of the table 410 comprises the captured image data displayed on the display screen 120 of the computing device 100. In some embodiments, the display screen 120 is transparent or semi-opaque, and the view 415 of the table 410 is realized by the table 410 being visible through the display screen 120.

The software application has a virtual function configured to manipulate a virtual object 420, which is displayed over the view 415 of the table 410, in a predefined way. In FIG. 4A, the virtual object 420 comprises a ball. The mapping module 210 maps a gesture over the table 410 to the virtual function using the captured image data. In this example, the gesture is a finger swipe at a location 430 on the table 410. In FIG. 4B, the user brings his hand 440 into view of the image capture device 110 so that his finger touches location 430 on the table 410. A view 445 of the user's hand 440 is made visible via the display screen 120, similar to the view 415 of the table 410.

In FIG. 4C, the user performs a finger swipe at location 430 on the table 410. The gesture detection module 230 detects this gesture. The virtual object manipulation module 240 manipulates the virtual object 420 in the predefined way of the virtual function corresponding to the detected gesture based on the mapping of the gesture to the virtual function. Here the corresponding virtual function comprises moving the ball horizontally in accordance with the finger swipe.

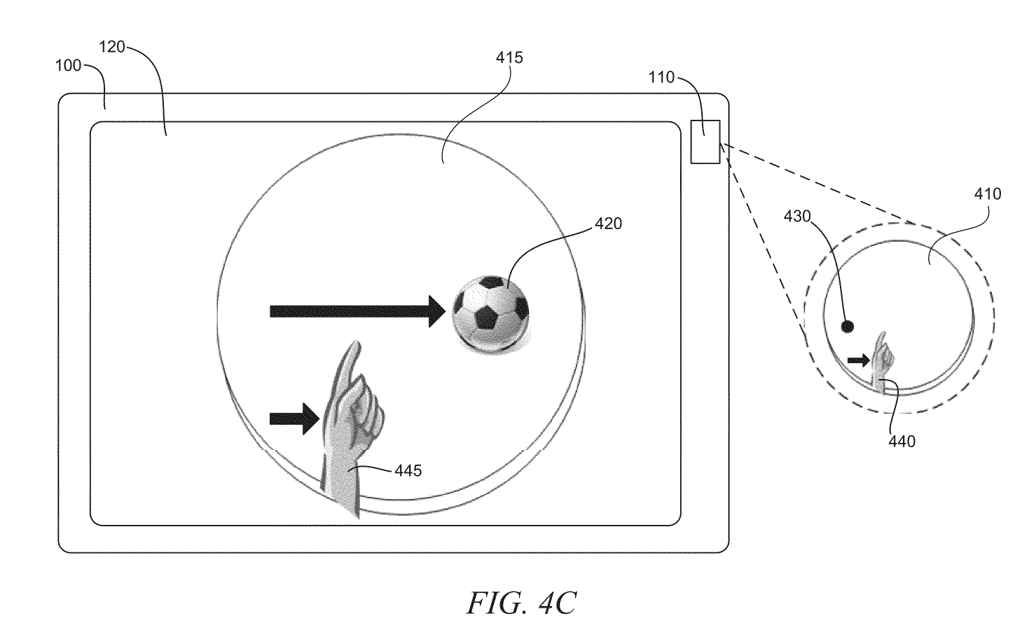

FIG. 5 is a flowchart illustrating a method of providing an augmented reality experience, in accordance with some embodiments. The operations of method 500 may be performed by a system or modules of a system (e.g., augmented reality module 150 in FIGS. 1-2). At operation 510, a software application may be run on a computing device 100. The software application may have a one or more virtual functions configured to manipulate one or more virtual objects of the software application in a one or more corresponding predefined ways. At operation 520, image data of a physical content may be captured using the computing device 100. At operation 530, one or more gesture(s) over the physical content may be mapped to the one or more corresponding virtual functions using the image data. At operation 540, the virtual object(s) may be displayed over a view of the physical content on a display screen 120 of the computing device 100. At operation 550, one or more of the gestures over the physical content may be detected. At operation 560, the virtual object(s) may be manipulated in the corresponding predefined way(s) based on the mapping of the gesture(s) to the virtual function(s) in response to the detection of the gesture(s) over the physical content.

At operation 570, it is determined whether or not the real-world physical content over which the virtual object(s) of the software application is to be experienced (e.g., displayed) has changed to different physical content. If it is determined that the physical content has changed, then the method 500 returns to operation 520, where image data of the different physical content is captured, and the method 500 continues as it did before. In this respect, the mapping of the gesture(s) to the virtual function(s) may change one or more times during a single run of the software application (e.g., without the user exiting the software application or without user restarting the software application).

If it is determined that the physical content has not changed, then, at operation 580, it is determined whether or not the software application continues to run. For example, the user of the software application may decide to exit or restart the application, in which case, the method would come to an end. If it is determined that the application will continue to run, then the method 500 returns to operation 540, where the virtual object(s) continue to be displayed over the view of the physical content on the display screen.

It is contemplated that the operations of method 500 may incorporate any of the other features disclosed herein.

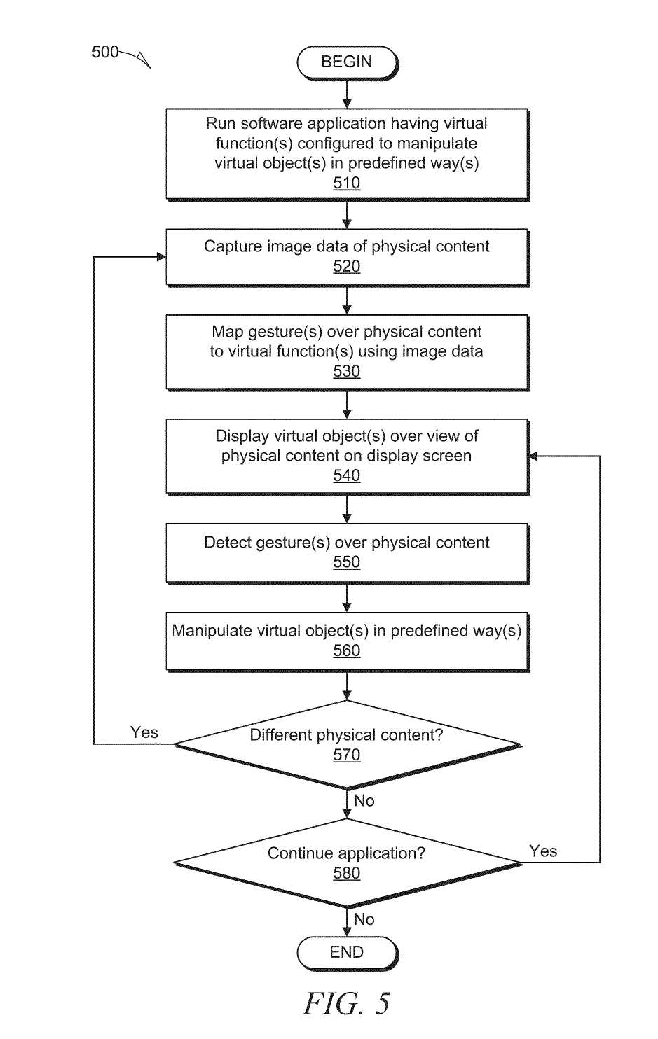

In some embodiments, the virtual functions of a software application have one or more corresponding parameters. These parameters may dictate how and under what conditions the virtual functions may be performed. Examples of virtual function parameters include, but are not limited to, position requirements for virtual objects in relation to particular aspects (e.g., boundaries) of the view of the physical content, as well as position requirements for gestures (e.g., a finger swipe) in relation to particular aspects of the view of the physical content. Other types of virtual function parameters are also within the scope of the present disclosure. FIG. 6 illustrates a mapping 600 of virtual functions to virtual functions parameters, in accordance with some embodiments. This mapping 600 may be a part of the software application or otherwise accessible to the computing device 100. In FIG. 6, Virtual Function 1 is mapped to Virtual Function Parameter(s) 1, Virtual Function 2 is mapped to Virtual Function Parameter(s) 2, Virtual Function 3 is mapped to Virtual Function Parameter(s) 3, and so on and so forth.

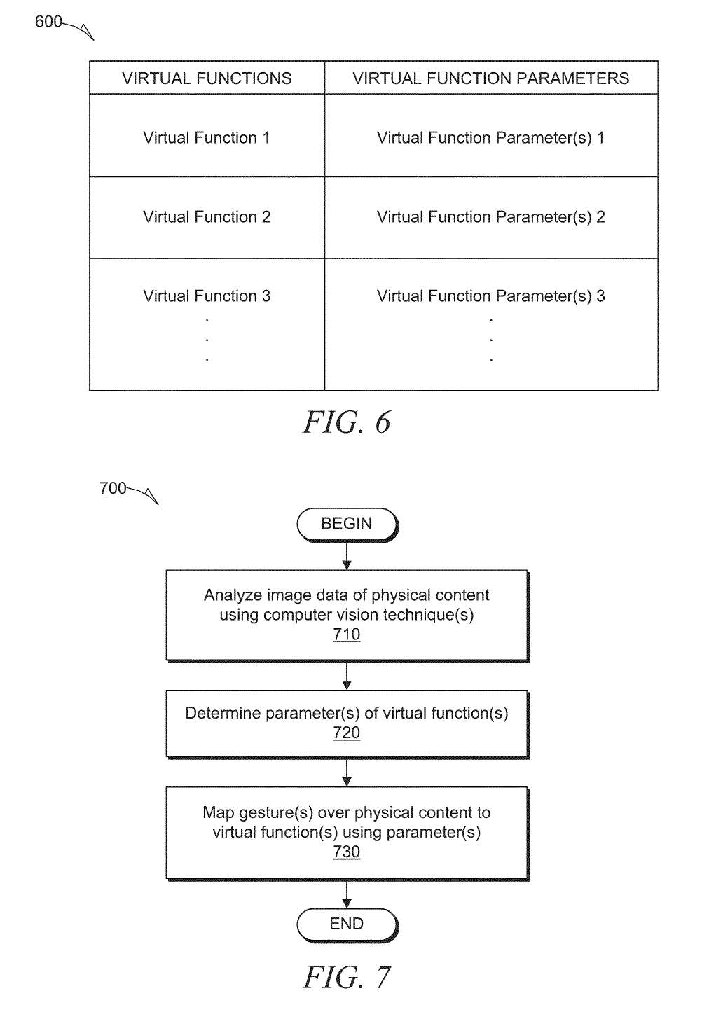

FIG. 7 is a flowchart illustrating a method of mapping gestures over physical content to virtual functions, in accordance with some embodiments. The operations of method 700 may be performed by a system or modules of a system (e.g., augmented reality module 150 in FIGS. 1-2). At operation 710, the image data of the physical content is analyzed using at least one computer vision technique. As previously discussed, computer vision techniques may include processing, analyzing, and understanding image data in order to produce information. Examples of computer vision techniques may include, but are not limited to, gesture recognition, image recognition, and object recognition. At operation 720, the corresponding virtual function parameter(s) of the virtual function(s) may be determined, such as by accessing a mapping of virtual functions to virtual function parameters. At operation 730, the corresponding gesture(s) over the physical content may be mapped to the virtual function(s) using the virtual function parameter(s) of the virtual function(s). It is contemplated that the operations of method 700 may incorporate any of the other features disclosed herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

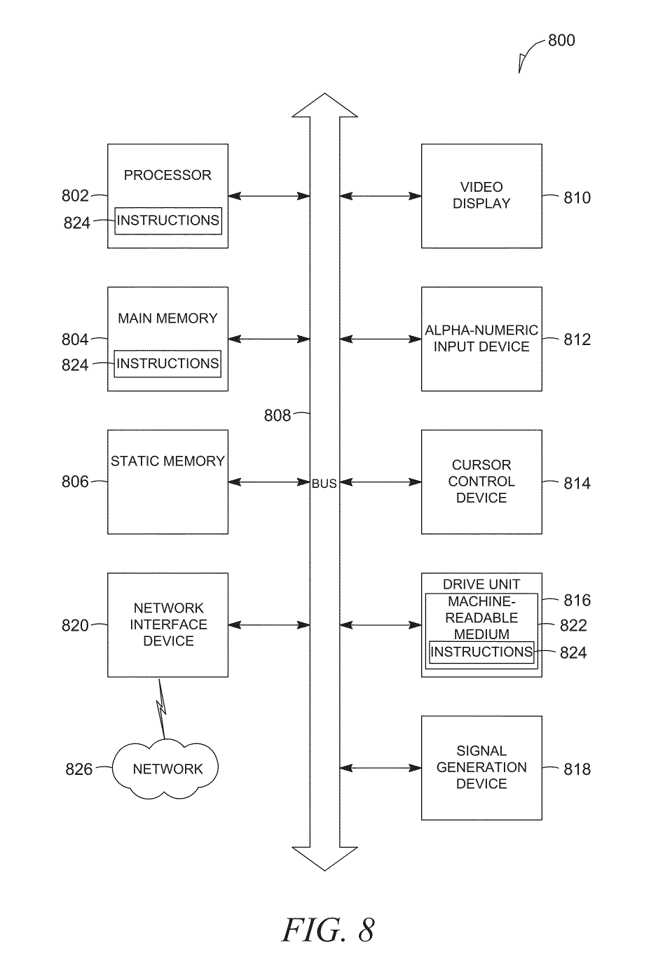

FIG. 8 is a block diagram of a machine in the example form of a computer system 800 within which instructions 824 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

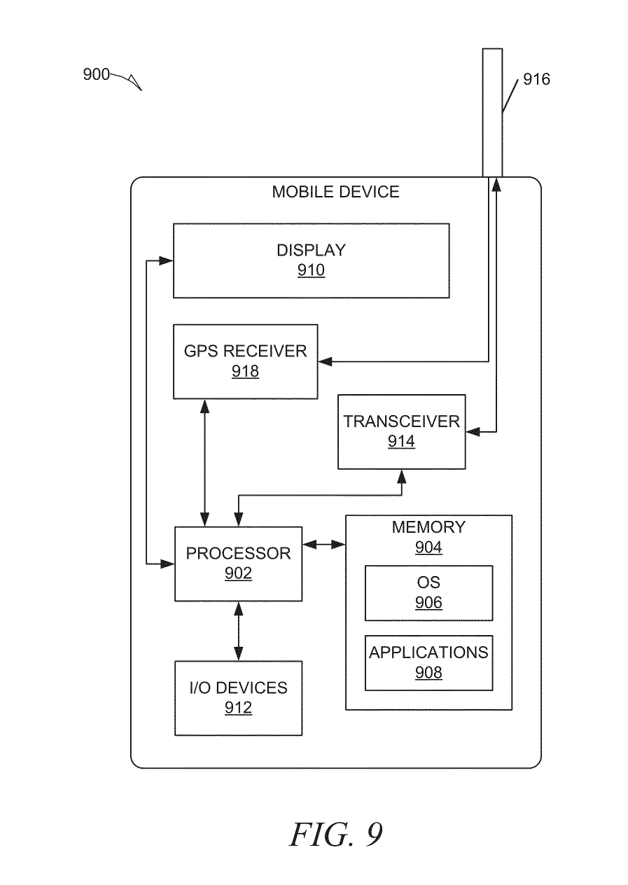

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user 102. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment

What is claimed is:

1. A computer-implemented method comprising:
running a software application on a computing device having a memory and at least one processor, the software application having a first virtual function configured to manipulate a virtual object of the software application in a first predefined way;
capturing first image data of a first physical content using the computing device;
mapping a first gesture over the first physical content to the first virtual function using the first image data;
displaying the virtual object over a view of the first physical content on a display screen of the computing device;
detecting the first gesture over the first physical content; and
manipulating the virtual object in the first predefined way in response to detecting the first gesture over the first physical content.

2. The method of claim 1, further comprising:
capturing second image data of a second physical content using the computing device;
mapping the first gesture over the second physical content to the first virtual function using the second image data;
displaying the virtual object over a view of the second physical content on the display screen of the computing device;
detecting the first gesture over the second physical content; and
manipulating the virtual object in the first predefined way in response to detecting the first gesture over the second physical content.

3. The method of claim 2, wherein the mapping of the first gesture over the first physical content to the virtual function using the first image data, the manipulating of the virtual object in the first predefined way in response to detecting the first gesture over the first physical content, the mapping of the first gesture over the second physical content to the virtual function using the second image data, and the manipulating of the virtual object in the first predefined way in response to detecting the first gesture over the second physical content are all performed during a single run of the software application.

4. The method of claim 1, wherein:
the first physical content comprises a physical object; and
the first gesture over the first physical content comprises a touch of a first location on a surface of the physical object.

5. The method of claim 1, wherein:
the first physical content comprises a physical space; and
the first gesture over the first physical content comprises a movement on a first location within the physical space.

6. The method of claim 1, wherein detecting the first gesture over the first physical content comprises detecting the first gesture using captured image data of the first gesture.

7. The method of claim 1, wherein the software application has a second virtual function configured to manipulate the virtual object of the software application in a second predefined way different from the first predefined way, and the method further comprises:
mapping a second gesture over the first physical content to the second virtual function using the first image data;
detecting the second gesture over the first physical content; and
manipulating the virtual object in the second predefined way in response to detecting the second gesture over the first physical content.

8. The method of claim 1, wherein mapping the first gesture over the first physical content to the first virtual function using the first image data comprises:
analyzing the first image data of the first physical content using at least one computer vision technique;
determining at least one parameter of the first virtual function; and
mapping the first gesture over the first physical content to the first virtual function using the at least one parameter of the first virtual function.

9. The method of claim 1, wherein the computing device comprises one of a smart phone, a tablet computer, a wearable computing device, and a vehicle computing device.

10. A system comprising:
a computing device having a memory and at least one processor;
an image capture device coupled to the computing device and configured to capture first image data of a first physical content;
a display screen coupled to the computing device;
an augmented reality module, executable by the at least one processor, configured to:
run a software application, the software application having a first virtual function configured to manipulate a virtual object of the software application in a first predefined way;
map a first gesture over the first physical content to the first virtual function using the first image data;
display the virtual object over a view of the first physical content on the display screen;
detect the first gesture over the first physical content; and
manipulate the virtual object in the first predefined way in response to detecting the first gesture over the first physical content.

11. The system of claim 10, wherein:
the image capture device is further configured to capture second image data of a second physical content; and
the augmented reality module is further configured to:
map the first gesture over the second physical content to the first virtual function using the second image data;
display the virtual object over a view of the second physical content on the display screen;
detect the first gesture over the second physical content; and
manipulate the virtual object in the first predefined way in response to detecting the first gesture over the second physical content.

12. The system of claim 11, wherein the augmented reality module is configured to perform the mapping of the first gesture over the first physical content to the virtual function using the first image data, the manipulating of the virtual object in the first predefined way in response to detecting the first gesture over the first physical content, the mapping of the first gesture over the second physical content to the virtual function using the second image data, and the manipulating of the virtual object in the first predefined way in response to detecting the first gesture over the second physical content are during a single run of the software application.

13. The system of claim 10, wherein:
the first physical content comprises a physical object; and
the first gesture over the first physical content comprises a touch of a first location on a surface of the physical object.

14. The system of claim 10, wherein:
the first physical content comprises a physical space; and
the first gesture over the first physical content comprises a movement on a first location within the physical space.

15. The system of claim 10, wherein the augmented reality module is configured to detect the first gesture over the first physical content using captured image data of the first gesture.

16. The system of claim 10, wherein the software application has a second virtual function configured to manipulate the virtual object of the software application in a second predefined way different from the first predefined way, and the augmented reality module is further configured to:
map a second gesture over the first physical content to the second virtual function using the first image data;
detect the second gesture over the first physical content; and
manipulate the virtual object in the second predefined way in response to detecting the second gesture over the first physical content.

17. The system of claim 10, wherein the augmented reality module is further configured to:
analyze the first image data of the first physical content using at least one computer vision technique;
determine at least one parameter of the first virtual function; and
map the first gesture over the first physical content to the first virtual function using the at least one parameter of the first virtual function.

18. The system of claim 10, wherein the computing device comprises one of a smart phone, a tablet computer, a wearable computing device, and a vehicle computing device.

19. A non-transitory machine-readable storage device, tangibly embodying a set of instructions that, when executed by at least one processor, causes the at least one processor to perform a set of operations comprising:
running a software application on a computing device, the software application having a first virtual function configured to manipulate a virtual object of the software application in a first predefined way;
receiving captured first image data of a first physical content;
mapping a first gesture over the first physical content to the first virtual function using the first image data;
displaying the virtual object over a view of the first physical content on a display screen of the computing device;
detecting the first gesture over the first physical content; and
manipulating the virtual object in the first predefined way in response to detecting the first gesture over the first physical content.

20. The non-transitory machine-readable storage device of claim 19, wherein the set of operations further comprise:
receiving second image data of a second physical content;
mapping the first gesture over the second physical content to the first virtual function using the second image data;
displaying the virtual object over a view of the second physical content on the display screen of the computing device;
detecting the first gesture over the second physical content; and
manipulating the virtual object in the first predefined way in response to detecting the first gesture over the second physical content.
